(19) United States
(12) Patent Application Publication
(10) Pub. No.: US 2008/0176125 A1
(43) Pub. Date: Jul. 24, 2008

(54) FUEL CELL

(75) Inventors: Eiko Kanda, Okegawa-shi (JP); Masahiro Wada, Ageo-shi (JP); Komei Kato, Saitama-shi (JP); Tsutomu Yoshitake, Tokyo (JP); Hidekazu Kimura, Tokyo (JP); Suguru Watanabe, Tokyo (JP)

Correspondence Address: DARBY & DARBY P.C., P.O. BOX 770, Church Street Station, New York, NY, 10008-0770, US

(73) Assignees: Mitsubishi Materials Corporation, Chiyoda-ku (JP); NEC Corporation, Tokyo (JP)

(21) Appl. No.: 12/014,917

(22) Filed: Jan. 16, 2008

(30) Foreign Application Priority Data
Jan. 18, 2007 (JP) 2007-009485

(51) Int. Cl. H01M 8/10

(52) U.S. Cl. 429/30

(57) ABSTRACT

A fuel cell includes electrode sheets composed of an electrically conductive porous body composed by a sheet member having a framework having a three-dimensional mesh structure containing pores, a catalyst layer formed on one side thereof, and a resin portion integrally formed on an outer peripheral edge; the electrically conductive porous body has a current collection portion formed in a portion thereof having a laminated structure consisting of a plurality of sheet members, and the pores in each sheet member of the current collection portion are formed to be pressed flatter than the pores of other portions; a resin penetrates into pores within the electrically conductive porous body at bound portions of the resin portion and the electrically conductive porous body; and, among a plurality of unit cells A and B, at least a portion thereof are connected in series by means of an electrically conductive member that passes through an electrolyte membrane from the current collection portion of the electrically conductive porous body.

### BACKGROUND OF THE INVENTION

1. Field of the Invention

The present invention relates to a fuel cell.

The present application claims priority on Japanese Patent Application No. 2007-9485, filed on Jan. 18, 2007, the content of which is incorporated herein by reference.

2. Description of the Related Art

Fuel cells are composed of composite units in the form of cells, and one cell (single cell) employs a structure in which different electrodes (fuel electrode and air electrode) interpose an electrolyte membrane such as a solid polymer. Fuel cells generate a large amount of electricity by linking large numbers of cells.

Electrode members composed of an electrically conductive porous body permeable to fuel gas and air are used for the fuel electrode and air electrode, and terminal tabs for an electrical connection are affixed to the electrode members by welding. In addition, the use of a metal foam sintered body having both favorable gas diffusivity and electrical conductivity has been proposed (see Patent Documents 1 and 2).

[Patent Document 1] Japanese Unexamined Patent Application, First Publication No. 2005-93274

[Patent Document 2] Japanese Unexamined Patent Application, First Publication No. 2005-5077

### SUMMARY OF THE INVENTION

Although the porosity of a porous body is preferably high for enhancing gas permeability, since metal components decrease if the porosity is excessively high, it becomes difficult to weld terminal tabs since the porous body ends up melting due to the heat during welding. In addition, since the terminal tabs are composed of an ingot material, permeation of gas is hindered by the terminal tab at locations where the terminal tab is welded over the porous body.

In addition, in the case of insert molding a resin frame surrounding an outer peripheral edge by injection molding as described in Patent Document 1, although the resin penetrates into the porous body resulting in the demonstration of anchoring effects, separation easily occurs in the terminal tabs due to the contractile force of the resin at locations where the terminal tabs are bound.

With the foregoing in view, an object of the present invention is to facilitate the formation of current collection terminals while also ensuring gas permeability at locations thereof as well as enhancing bonding strength with resin portions of outer peripheral edges.

The fuel cell of the present invention is provided with a solid polymer electrolyte membrane and electrode sheets layered on both sides of the electrolyte membrane; wherein, the electrode sheets are composed of an electrically conductive porous body composed by a sheet member having a framework having a three-dimensional mesh structure, a catalyst layer formed on one side of the electrically conductive porous body and made to contact the electrolyte layer, and a resin portion integrally formed by extending at least a portion of an outer peripheral edge of the electrically conductive porous body in a horizontal direction, the electrically conductive porous body has a current collection portion formed to have a density in a portion thereof that is higher than other portions, a resin penetrates into pores within the framework of the electrically conductive porous body at bound portions of the resin portion and the electrically conductive porous body, and among the plurality of unit cells composed by the electrolyte membrane and the electrode sheets on both sides thereof, at least a portion thereof are connected in series by means of an electrically conductive member that passes through the electrolyte membrane from the current collection portion of the electrically conductive porous body.

In other words, since density in the current collection portion is increased, the amount of metal in this portion is greater than that in other portions, which together with resulting in superior electrical characteristics, facilitates welding and the like. Moreover, even in the case of forming a resin portion at the peripheral edge of this current collection portion, the resin penetrates into the pores of the framework forming the current collection portion and is securely hound.

In this case, together with having a laminated structure of a plurality of sheet members, the current collection portion may also adopt a configuration in which the pores in the framework of each sheet member in the current collection portion are formed to be pressed flatter than the pores of other portions.

As a result of employing such a configuration, a high-density current collection portion can be easily produced as a result of being pressed flat by laminating the sheet members.

In addition, in this fuel cell, the sheet members in the current collection portion may have a configuration in which a dense sintered layer not having the aforementioned pores is formed on the surface layer thereof.

As a result of employing such a configuration, since the surface layer of the current collection portion consists of a dense layer of a sintered member, this surface layer contains a large amount of metal thereby resulting in superior electrical characteristics and weldability.

In this case, the porosity of the current collection portion is 40% to less than 60%, while the porosity of other portions is preferably 60% to 98%.

Furthermore, there are two types of typical fuels used in solid polymer fuel cells consisting of hydrogen gas and aqueous methanol solution. In the case of using hydrogen gas, although the fuel that flows through the electrically conductive porous body of the electrode sheets is a gas, in the case of using an aqueous methanol solution, the fuel that flows through the electrically conductive porous body of the electrode sheets is a liquid.

Since the density of the three-dimensional mesh structure of the framework in the current collection portion of the electrically conductive porous body of the electrode sheets of the fuel cell of the present invention is increased, the amount of metal in the current collection portion is higher than other portions of the main body, which together with resulting in superior electrical characteristics facilitates welding and the like. Moreover, even in the case of a resin portion being formed in the peripheral edge of this current collection portion, the resin of the resin portion penetrates into the pores of the framework of the current collection portion and is strongly bound.

### BRIEF DESCRIPTION OF THE DRAWINGS

FIG. 1 is an exploded perspective view of a cell in a fuel cell of one embodiment of the present invention.

FIG. 2 is a longitudinal cross-sectional view of a fuel cell produced by assembling the cell of FIG. 1.

FIG. 3 is an enlarged cross-sectional view of the essential portion of an electrically conductive porous body used in the embodiment of FIG. 1.

FIG. 4 is a schematic drawing showing a green sheet production apparatus for producing a sheet member used in the electrically conductive porous body of FIG. 3.

FIG. 5 is a cross-sectional view showing the production of an electrically conductive porous body using a sheet member produced with the apparatus of FIG. 4.

FIG. 6 is a longitudinal cross-sectional view showing an injection molding apparatus for integrally molding a resin portion in an electrically conductive porous body produced according to FIG. 5.

FIG. 7 is a longitudinal cross-sectional view showing a resin portion molded in an electrically conductive porous body with the injection molding apparatus of FIG. 6.

FIG. 8 is a schematic drawing showing a testing apparatus for measuring the bonding strength of an electrically conductive porous body.

FIG. 9 is an exploded perspective view of the same cell as FIG. 1 showing an example in which the size of the electrically conductive porous body has been changed.

FIG. 10 is a longitudinal cross-sectional view of a fuel cell produced by assembling the cell of FIG. 9.

FIG. 11 is a cross-sectional view showing a lamination example using three layers of a sheet member when forming an electrically conductive porous body.

FIG. 12 is a cross-sectional view showing a lamination example in which the porosity of the intermediate layer of three layers of a sheet member has been increased when forming an electrically conductive porous body.

FIG. 13 is a cross-sectional view showing an example of having laminated sheet members having-different porosities in the direction of thickness when forming an electrically conductive porous body.

FIG. 14 is a schematic drawing showing a green sheet production apparatus for producing sheet members having different porosities in the direction of thickness of FIG. 13.

FIG. 15 is an enlarged cross-sectional view of the essential portion of a sheet member produced with the green sheet production apparatus of FIG. 14.

FIG. 16 is a perspective view showing another embodiment of an electrode sheet formed by causing a current collection portion to protrude to the outside of a resin portion.

### BRIEF DESCRIPTION OF THE REFERENCE SYMBOLS

1: fuel cell, 2: electrolyte membrane, 4: electrode sheet, 5: fuel supply portion, 6: fuel electrode, 7: air electrode, 11: electrode member, 12: resin portion, 13,13A,13B: electrically conductive porous body, 14: catalyst layer, 15: main body, 16; current collection portion, 17: pore, 18: framework, 19: sheet member, 27: terminal tab, 31: green sheet production apparatus, 32: slurry, 33: hopper, 34: carrier sheet, 35: doctor blade, 37: slurry sheet, 38: foaming tank, 39: heating oven, 40: green sheet, 51: injection molding; apparatus, 52: moving die, 53: stationary die, 54: cavity, 61: sheet member, 62: dense sintered layer, 63: sheet member, 64: hopper, 65: green sheet production apparatus 66: slurry, 67: doctor blade, 68: slurry sheet, 69: green sheet, 71: resin impregnated portion

### DESCRIPTION OF THE PREFERRED EMBODIMENTS

The following provides an explanation of embodiments of the fuel cell of the present invention based on the drawings.

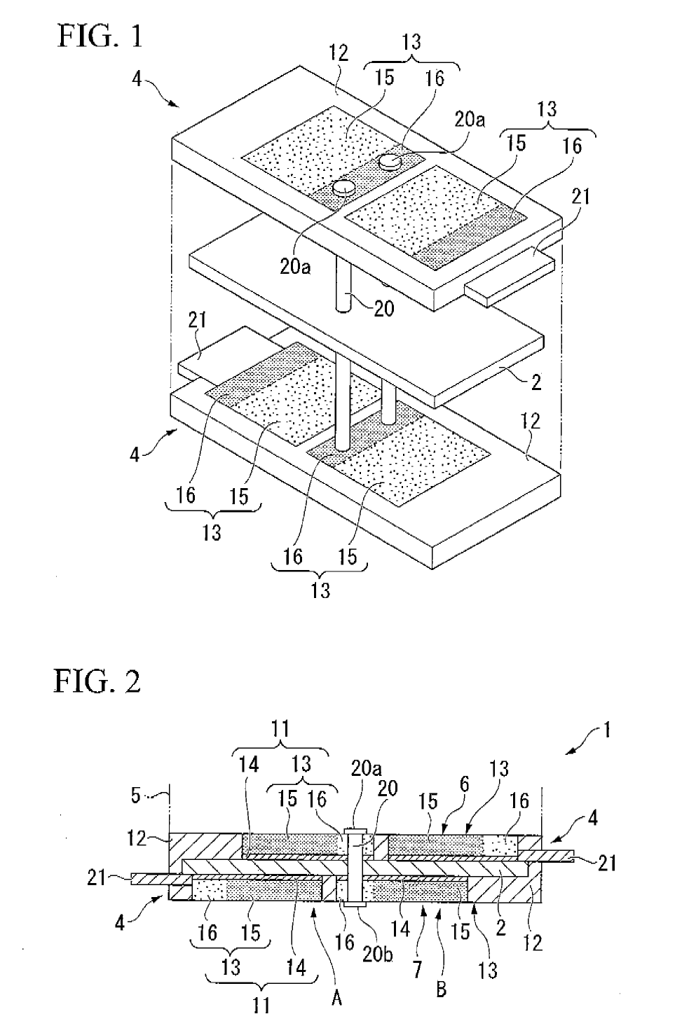

The fuel cell of this embodiment is applied to a fuel cell having a horizontally arranged structure in which a plurality of unit cells are horizontally arranged as shown in FIG. 1.

This fuel cell 1 is composed by being provided with a solid polymer electrolyte membrane 2 and a pair of electrode sheets 4 layered on both sides of this electrolyte membrane 2, as a result of providing a fuel supply portion 5 in the upper electrode sheet 4 in FIG. 2 of one of the electrode sheets 4, and causing the other electrode sheet 4 to contact the airs the upper side in FIG. 2 is taken to be a fuel electrode 6 while the lower side is taken to be an air electrode 7.

The electrode sheets 4 employ a configuration in which a plurality of electrode members 11 arranged at an interval in the horizontal direction, and a frame-like resin portion 12 is provided so as to fill in the space between these electrode members 11 as well as surround the entire outer periphery. In the example of FIG. 1, two electrode members 11 are arranged side by side and integrated by the resin portion 12.

The electrode members 11 employ a configuration in which a catalyst layer 14 is formed on one side of an electrically conductive porous body 13, and the electrically conductive porous body 13 employs a configuration provided with a main body 15 and a current collection portion 16 formed in a portion of the main body 15.

As shown in FIG. 1, together with the main body 15 being formed in the shape of a square sheet, the current collection portion 16 is formed into the shape of a strip so as to compose one side of the main body 15 by extending along that side, with both being formed to the same thickness and the surfaces thereof lying in the same plane.

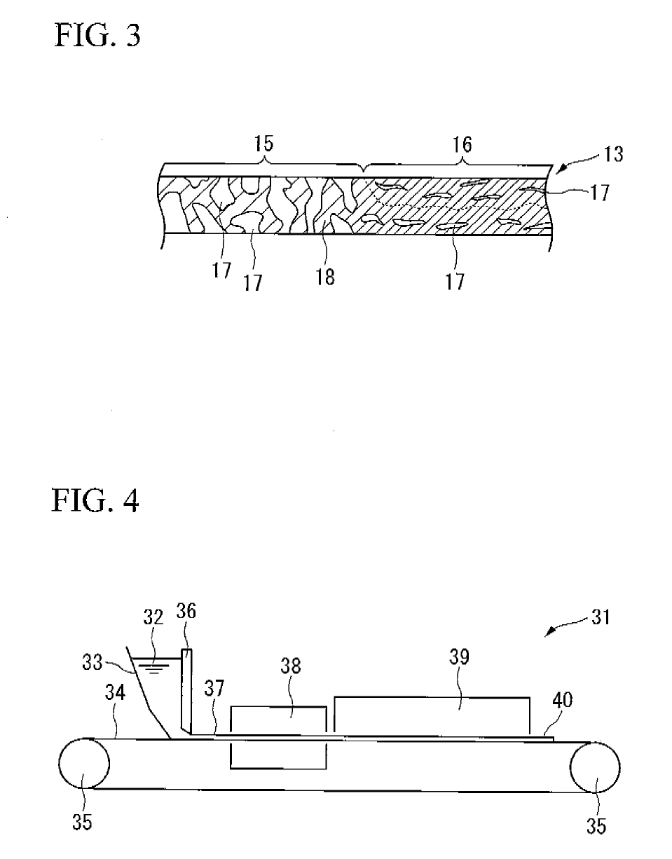

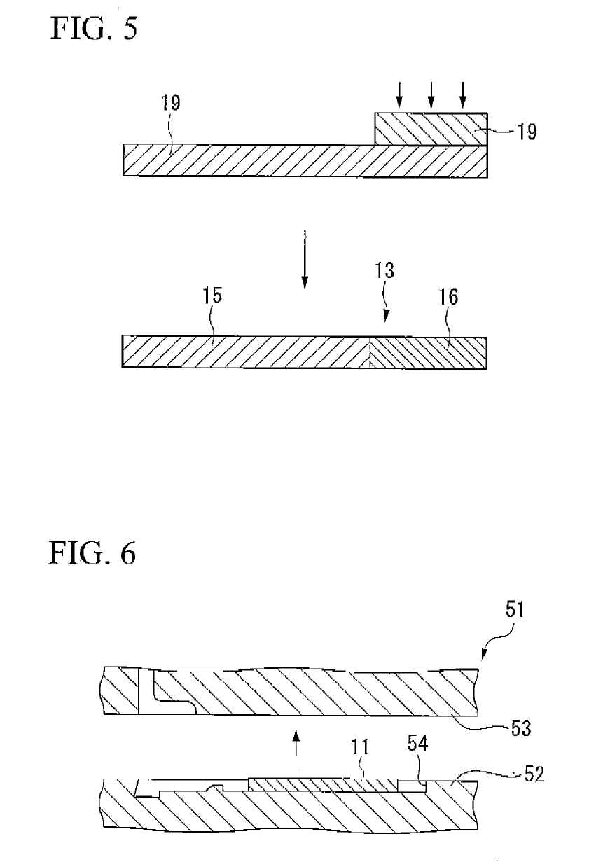

In addition, the main body 15 and the current collection portion 16 are produced based on a metal foam sheet member 19 having a framework 18 having a three-dimensional mesh structure containing pores 17 (see FIGS. 3 and 5), the main body 15 uses the sheet member 19 as is, while the current collection portion 16 is formed by laminating another sheet member 19 in the shape of a narrow strip on the sheet member 19 composing the main body 15 and pressing these together. Thus, as shown in FIG. 3, although the pores 17 contained in the framework 18 having a three-dimensional mesh structure are maintained in a comparatively large state in the main body 15, the pores 17 of the current collection portion 16 are pressed flat.

In addition, the main body 15 and the current collection portion 16 are formed with the same material, and are composed by, for example, a highly corrosion-resistant metal such as SUS316 or other stainless steel, titanium or Hastelloy.

The electrode members 11 are obtained by forming a catalyst layer 14 such as platinum or platinum-ruthenium on one side of the electrically conductive porous body 13 configured in this manner, and as shown in FIG. 1, the electrode sheets 4 are composed by arranging two electrode members 11 side by side in the horizontal direction and integrally forming the resin portion 12 so as to fill in the space there between as well as surround the outer periphery.

Each electrode sheet 4 has the catalyst layer 14 facing towards the solid polymer electrolyte membrane 2 on both sides of the electrolyte membrane 2, and as shown in FIG. 1, the arrangement of the current collection portion 16 of each electrically conductive porous body 13 in both electrode sheets 4 is superimposed so as to be laterally inverted. In addition, although two unit cells A and B are composed to the left and right in this superimposed state, among these, in the example of FIG. 1 and FIG. 2, the current collection portions 16 of both electrically conductive porous bodies 13 are vertically aligned and arranged in the direction of thickness in the fuel electrode 6 of the left unit cell A and the air electrode 7 of the right unit cell B, and as a result of electrically conductive members 20 passing through these current collection portions 16 together with the electrolyte membrane 2, the two unit cells A and B are connected in series. These electrically conductive members 20 are composed of metal rivets and the like, and the upper ends 20a and the lower ends 20b thereof are widened by flattening.

In this case, the electrically conductive members 20 may be provided at a single location or a plurality of locations. In addition, in the case of using a liquid fuel, a sealing agent is provided to prevent leakage of liquid from the penetrating portions of the electrically conductive members 20.

A terminal tab 21 is respectively connected by welding and the like to each lateral surface of the current collection portion 16 of the electrically conductive porous body 13 arranged on one end in the direction of arrangement of one of the electrode members 11 (the current collection portion on the right end of the upper electrode member 11 in the example of FIGS. 1 and 2) and the current collection portion 16 of the electrically conductive porous body 13 arranged on the opposite end in the direction of arrangement of the other electrode member 11 (the current collection portion on the left end of the lower electrode member 11 in the example of FIGS. 1 and 2) and led to the outside. Thus, in this fuel cell 1, one of the terminal tabs 21 is connected in series to the other terminal tab 21 through electrically conductive porous bodies 13 of electrode members 11r electrolyte membrane 2 and electrically conductive members 20.

In the feel cell 1 configured in the manner described above, hydrogen contained in a fuel supplied from the fuel supply portion 5 to the electrode sheet 4 of the fuel electrode 6 releases electrons due to an electrode reaction on the catalyst layer 14 resulting in the formation of hydrogen ions. The electrons released at this time migrate from the fuel electrode 6 to the air electrode 7 through an external pathway (not shown) via the terminal tabs 21, and electrical energy is generated as a result of that migration. On the other hand, in the air electrode 7, oxygen in the air supplied from the electrode sheet 4 accepts the electrons and the hydrogen ions that have migrated to the air electrode 7 through the electrolyte membrane 2 are supplied thereto resulting in the formation of water. This water is then discharged outside the system along with excess air. In the operation of this type of fuel cell, the resin portion 12 formed on the electrode sheet 4 functions as a sealing member that blocks the space between adjacent cells A and B.

Next, an explanation is provided of a process for producing the electrode sheet 4.

Firsts a process for producing the electrically conductive porous body 13 of this electrode sheet 4 is explained.

As was previously described, the electrically conductive porous body 13 is produced based on a metal foam sheet member 19 having a framework 18 having a three-dimensional mesh structure containing pores 17, and this sheet member 19 is produced by firing a green sheet obtained by thinly molding a slurry containing a metal powder followed by drying.

This slurry consists of a mixture of a metal powder, a foaming agent (such as a non-water-soluble, hydrocarbon-based organic solvent having 5 to 8 carbon atoms, examples of which include neopentane, hexane and heptane), an organic binder (such as methyl cellulose or hydroxypropyl methyl cellulose) a solvent (water) and the like. A green sheet production apparatus 31 in which this slurry is thinly molded with a doctor blade is shown in FIG. 4.

In this green sheet production apparatus 31, a slurry 32 is supplied from a hopper 33 in which the slurry 32 is stored onto a carrier sheet 34. The carrier sheet 34 is transported by a roller 35, and the slurry 32 on the carrier sheet 34 is stretched between the moving carrier sheet 34 and a doctor blade 36 so as to mold into the shape of a sheet having a prescribed thickness.

This slurry sheet 37 is further transported by the carrier sheet 34 and sequentially passes through a foaming tank 38, where heat treatment is carried out, and heating oven 39. In the foaming tank 38, since heat treatment is carried out in a high humidity atmosphere, foam pores can be formed by foaming the foaming agent without allowing cracks to form in the slurry sheet 37. At this time, adjacent foam pores in the direction of thickness become connected, and together with forming openings in the top and bottom surfaces of the slurry sheet 37 as a result of extending to the top and bottom surfaces thereof, adjacent foam pores in the horizontal direction also become connected. When this slurry sheet 37 is dried in heating oven 39, a green sheet 40 is formed in the state in which the metal powder is bound by the organic binder.

After having removed this green sheet 40 from the carrier sheet 34, the green sheet 40 is degreased and fired in a vacuum oven not shown to remove the organic binder, sinter the metal powder and obtain a metal foam sheet member 19 having a framework 18 exhibiting a three-dimensional mesh structure containing pores 17 attributable to the foam pores. The sheet member 19 produced in this manner has a porosity of 60% to 98%.

This sheet member 19 is then cut to produce a flat sheet of the size of the electrically conductive porous bodies 13 and a narrow strip of the size of the current collection portions 16. As shown in FIG. 5, when the strip-shaped sheet member 19 is layered over one side of the plate-shaped sheet member 19, and these layered portions are pressed together in the direction of thickness to form a single sheet overall, the electrically conductive porous body 13 is produced in which the current collection portion 16 is formed on one side of the main body 15. The porosity of the main body 15 of this electrically conductive porous body 13, excluding the current collection portion 16, is equal to the porosity of the sheet member 19 at 60% to 98%, while the current collection portion 16 is compressed to an overall thickness of 80% or less that prior to lamination, and the porosity thereof is 40% to less than 60%. In addition, as shown in FIG. 3, although the pores 17 of the main body 15 are formed to be nearly round, the pores 17 of the current collection portion 16 are formed to be pressed flat.

After having formed the electrode member 11 by forming the catalyst layer 14 on one side of the plurality of electrically conductive porous bodies 13 produced in this manner, the resin portion 12 is integrally formed in the electrode member 11 to produce the electrode sheet 4.

Next, an explanation is provided of a method for obtaining the electrode sheet 4 by forming the resin portion 12 on this electrode member 11.

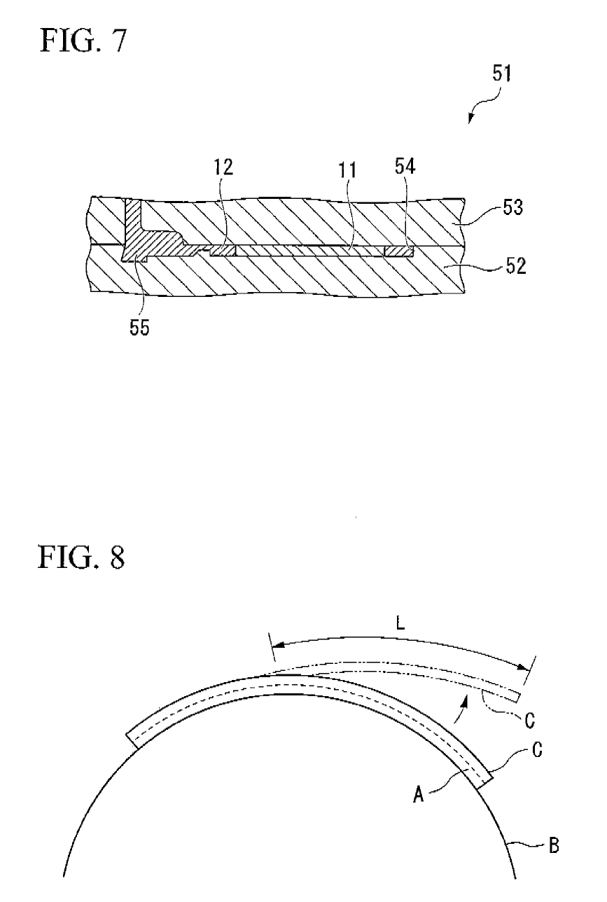

As shown in FIG. 6, a cavity 54 of a size enabling formation of the electrode sheet 4 is formed between a moving die 52 and a stationary die 53 of an injection molding apparatus 51. After arranging a plurality of electrode members 11 in this cavity 54, the mold is clamped and the electrode members 11 are clamped between the moving die 52 and the stationary die 53. At this time, the electrode members 11 are clamped by both dies 52 and 53 so as to be only slightly compressed. Next, as shown in FIG. 7, when a resin 55 is injected into the gap formed around the electrode members 11, the resin 55 fills up the space between the electrode members 11 together with forming the resin portion 12 around the periphery thereof.

Since the electrode sheet 4 produced in this manner has a configuration in which pores 17 are contained in framework 18 having a three-dimensional mesh structure for both main body 15 and current collection portion 16 of electrically conductive porous body 13, gas permeability is superior due to these pores 17. In this case, although the current collection portion 16 is also pressed flat, since the pores 17 remain flat, the current collection portion 16 has gas permeability, thereby making it possible demonstrate a gas permeation function over the entire surface together with the main body 15.

In addition, since this current collection portion 16 is formed by pressing together two sheet members 19, the amount of metal is greater than that of the main body 15, thereby resulting in superior electrical characteristics. In addition, due to the large amount of metal, the current collection portion 16 is not melted by heat even in the case of the terminal tab 21 being attached to a lateral surface of the current collection portion 16 by welding and the like, thereby enabling a favorable connection.

Moreover, since a configuration is employed in which both sheet members 19 have the pores 17 around the periphery of the framework 18 having a three-dimensional mesh structure, the frameworks 18 having a three-dimensional mesh structure of both sheet members 19 penetrate each other and are intricately intermingled at the bonding surfaces of both sheet members 19 in the current collection portion 16, thereby resulting in strong bonding.

An experiment like that described below was carried cut to confirm the bonding strength of both sheet members employing this configuration.

Two types of test pieces were prepared using a sheet member composed of a framework having a three-dimensional mesh structure for the base material but having different porosities. In addition, a sheet member composed of a framework having a three-dimensional mesh structure and a metal sheet were prepared for the material laminated onto the base material. The sheet members composed of a framework having a three-dimensional mesh structure both had thicknesses of 0.3 mm, and the thickness of the metal sheet was 0.1 mm. In Table 1, the sheet members composed of a framework having a three-dimensional mesh structure are referred to as metal foam.

TABLE 1

| | Base | Laminated | |
|---|---|---|---|
| | Material | Material | Bonding Method |
| Example 1 | Metal foam | Metal foam | Pressed to a thickness equal to |
| | (70%) | (70%) | half the laminated thickness |
| Example 2 | Metal foam | Metal foam | Pressed to a thickness equal to |
| | (80%) | (80%) | half the laminated thickness |
| Comparative | Metal foam | Metal sheet | 3-point resistance welding at |
| Example 1 | (70%) | | equal intervals in the direction |
| | | | of length |
| Comparative | Metal foam | Metal sheet | 9-point resistance welding at |
| Example 2 | (70%) | | equal intervals in the direction |
| | | | of length |
| Comparative | Metal foam | Metal sheet | 9-point laser welding at equal |
| Example 3 | (70%) | | intervals in the direction of |
| | | | length |

The porosity after pressing in the two examples were 40% in Example 1 and 604 in Example 2.

These five types of test pieces were cut to a width of 10 mm and length of 110 mm followed by measuring the length L of the portion at which laminated material 0 separated when the side of base material A was wrapped around a cylinder B having an cuter diameter of 110 mm as shown in FIG. 8. The results were shown in Table 2.

TABLE 2

| | Length of Separated Portion |
|---|---|
| Example 1 | 0 mm |
| Example 2 | 0 mm |
| Comparative Example 1 | 87 mm |
| Comparative Example 2 | 30 mm |
| Comparative Example 3 | 89 mm |

In this manner, separation was not observed for Example 1 or 2, thus indicating adequate bonding strength.

In addition, since the electrode sheet 4 is obtained by integrally forming the electrically conductive porous body 13r having a framework is having a three-dimensional mesh structure containing pores 17, with the resin portion 12, the resin of the resin portion 12 penetrates into the pores 17 in the vicinity of the periphery of the electrically conductive porous body 13 at the peripheral portions of the electrically conductive porous body 13 resulting in strong bonding. In particular, since the resin portion 12 is formed by injection molding of the electrically conductive porous body 13 in the form of an insert component as previously described, resin can be made to effectively penetrate into the pores 17 of the electrically conductive porous body 13 by the injection pressure. In this case, although the current collection portion 16 is also pressed flat, since flat pores 17 are also present, resin is able to be made to penetrate into the pores 17 thereby making it possible to ensure high bonding strength.

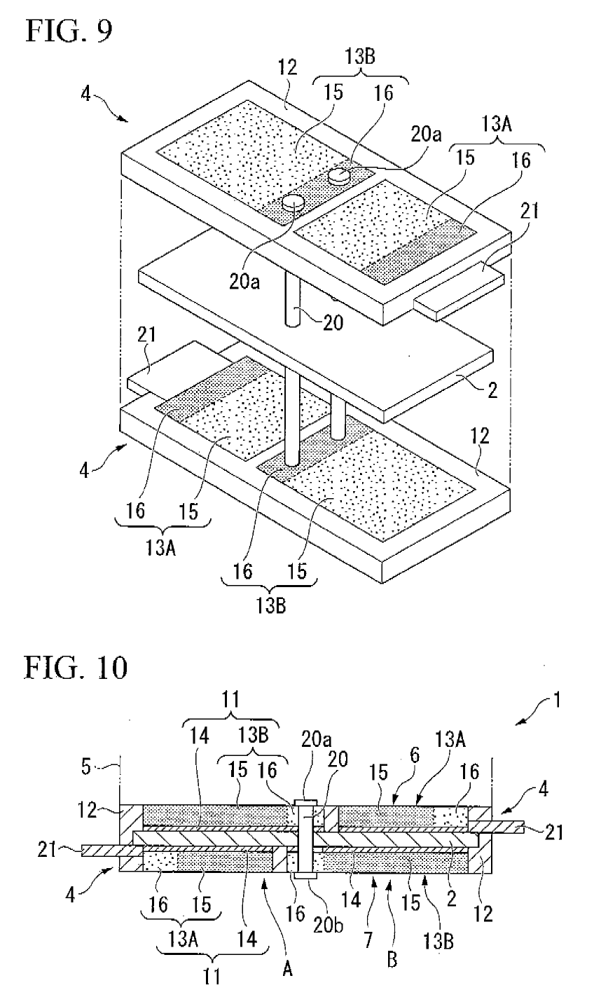

Furthermore, in the aforementioned embodiment, although the electrode sheets 4 employ a configuration in which electrically conductive porous bodies 13 of the same size are arranged in a row an integrated by the resin portion 12, and made to be in opposition while shifting the locations of the electrically conductive porous bodies 13 between the fuel electrode 6 and the air electrode 7 as shown in FIGS. 1 and 2, as shown in FIGS. 9 and 10, a configuration may also be employed in which electrically conductive porous bodies 13A and 133 are opposed over nearly their entire surface in both electrode sheets 4 by changing the size of each electrically conductive porous body 13, a plurality of which are arranged in a row in the fuel electrode 6 and the air electrode 7.

In additions although the current collection portions of the electrically conductive porous bodies are configured by pressing two sheet members together, a configuration may also be employed in which three or more sheets are pressed together.

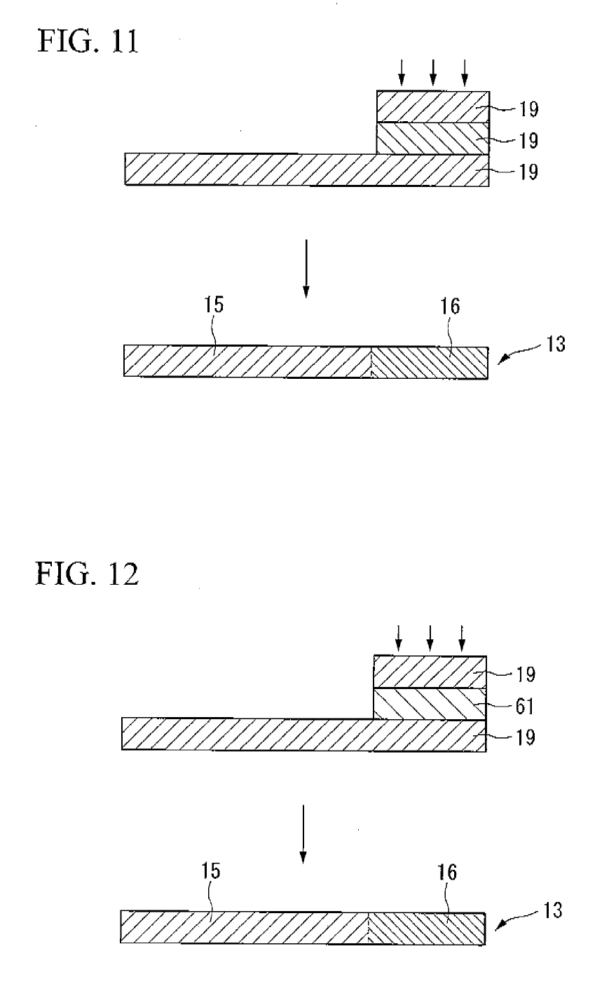

FIG. 11 shows an example of the current collector portion 16 is composed by pressing together three sheet members 19, and the resulting configuration has two strip-like sheet members 19 layered and pressed together on a sheet member 19 composing the main body 15. In this case, each sheet member 19 has an overall thickness of, for example, 0.4 mm and porosity of 85%, and are pressed together so that entire structure following lamination of these sheet members 19 has a thickness of, for example, 0.3 mm, and are finished to that in which the porosity of the portion corresponding to main body 15 is 80% and the porosity of the portion corresponding to current collection portion 16 is 40%. The thickness and quantity of sheet members 19 for composing the current collection portion 16 may be determined based on the final finished thickness and the relationship with the porosity obtained at that thickness. In addition, in the example of FIG. 11, although two strip-like sheet members 19 are layered on a flat sheet member 19 composing the main body 15, a configuration may also be employed in which strip-like sheet members 11 are placed on both sides of the sheet member 19 composing the main body 15.

Although FIG. 12 shows an example of three sheet members having been pressed together to compose a current collection portion in the same manner as FIG. 11, a sheet member 19 having a porosity of, for examples 85% is used for the sheet member 19 composing the main body 15 and uppermost sheet member 19 of the current collection portion 16, while a sheet member 61 in the form of an intermediate layer of the current collection portion 16 has a higher porosity than the layers on both sides, and that having a porosity of, for example, 90% is used. The thickness of all members is, for example, 0.4 mm.

As a result of layering these sheet members 19 and 61 and pressing to a thickness of, for example, 0.3 mm, the portion corresponding to the main body 15 is finished to a porosity of 80% while the portion corresponding to the current collection portion 16 is finished to a porosity of 47%.

In an electrically conductive porous body 13 employing such a configuration, since the intermediate sheet member 61 prior to lamination has high porosity and contains numerous pores 17 (see FIG. 3), the framework 18 having a three-dimensional mesh structure of the sheet members 19 on both sides are able to easily enter the pores 17 of the intermediate sheet member 61A and as a result of layering and pressing thereof, each sheet member 19 and 61 is bonded more strongly.

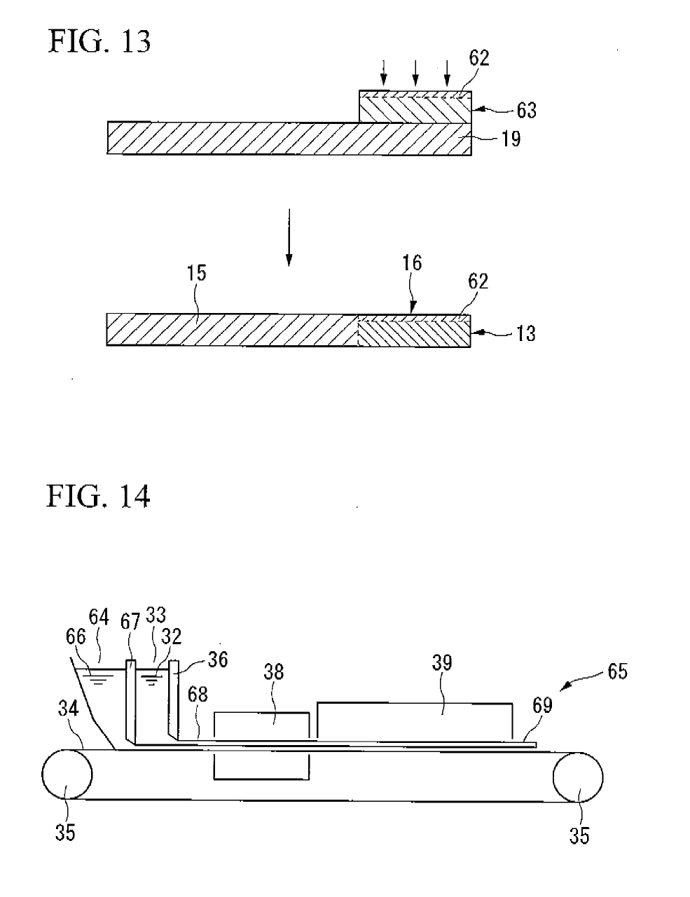

FIG. 13 shows an example of applying a configuration in which the porosity thereof differs in the direction of thickness for the strip-like sheet members layered in the current collection portion, and in this example of FIG. 13, a sheet member 63 is used in which a dense sintered layer 62 is formed on the surface thereof.

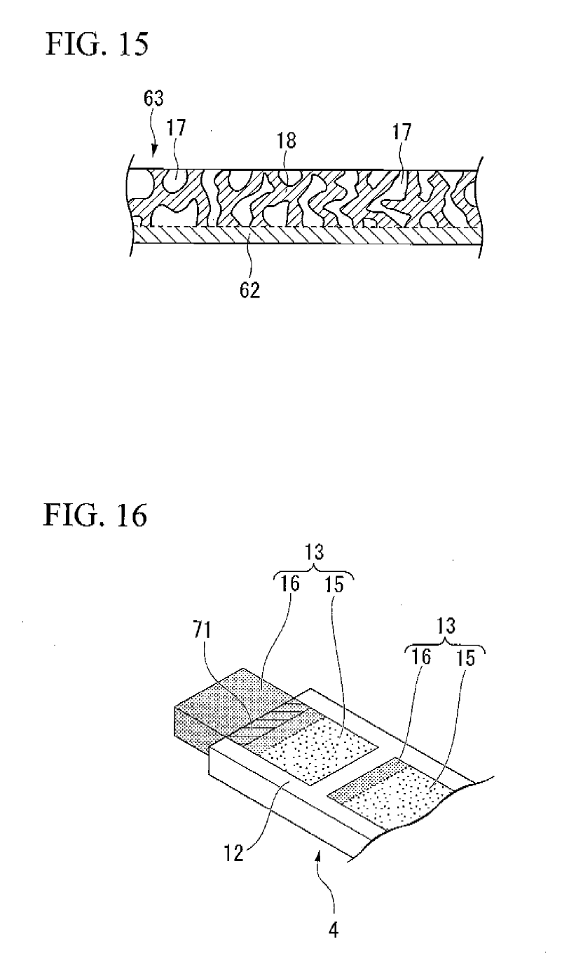

As shown in FIG. 14, a green sheet production apparatus 65 is used having two hoppers 33 and 64. A slurry 32 mixed with a foaming agent is stored in one of the hoppers 33, while a slurry 66 consisting of a metal powder, organic binder, solvent and the like but not containing a foaming agent is stored in the other hopper 64. The slurry 66 not containing a foaming agent is molded into a thin sheet by a doctor blade 67 while being supplied on a carrier sheet 34, and the slurry 32 containing a foaming agent is supplied from the other hopper 33 and layered thereon in the form of a sheet. A green sheet 69 in which only the upper layer is foamed is thus formed by heat-treating this double-layer slurry sheet 68. As a result of sintering this green sheet 69, the sheet member 63 is formed in which the upper layer consists of a metal foam layer composed of a framework 18 having a three-dimensional mesh structure containing pores 17 while the lower layer consists of the dense sintered layer 62 as shown in FIG. 15.

The electrically conductive porous body 13 shown in FIG. 13 is the result of obtaining a current collection portion 16 by layering this sheet member 63 on an ordinary sheet member 19 with the dense sintered layer 62 on the outside followed by pressing together.

Since the dense sintered layer 62 on the outer surface of current collection portion 16 is an ordinary sintered member and has a high metal density, this electrically conductive porous body 13 has superior electrical characteristics and can be reliably connected even by welding a lead wire. Moreover, since the bonding surface with the sheet member 19 composing the main body 15 is a metal foam layer, the frameworks having a three-dimensional mesh structure of both sheet members 19 and 63 are intricately intermingled resulting in strong bonding.

FIG. 16 shows an electrode sheet of still another embodiment. In this electrode sheet 4, a current collection unit 16 of an electrically conductive porous body 13 arranged on an end among a plurality of electrically conductive porous bodies 13 is formed to be larger than those of other electrically conductive current bodies 13, and by subsequently impregnating a resin so as to cross the current collection portion 16 in an open state, resin impregnated portion 71 is formed so as to connect resin portion 12.

As a result of employing this configuration, a structure results in which the current collection portion 16 protrudes to the outside, thereby facilitating electrical connection with the outside.

Since this current collection portion 16 also has pores 17 in this manner and can be integrated by impregnating a resin in pores 17, resin portion 12 can be easily formed by not only injection moldings but by other methods as well.

Examples of methods for forming this resin portion include methods using insert formation and resin impregnation during injection, and methods consisting of forming the resin into the shape of rods by injection molding and the like in advance, followed by pressure welding into an electrically conductive porous body while heating.

Furthermore, although the example of FIG. 1 shows an example of applying the electrode sheet to a horizontally arranged fuel cell, it may also be applied to a stacked fuel cell in which the cells are stacked in the direction of thickness.

In addition, although the pores of the electrically conductive porous body were formed by mixing a foaming agent into a slurry for forming a green sheet followed by foaming the resulting mixture, the formation of the pores is not limited thereto, but rather can also be formed by mixing beads that disappear due to heat during sintering into the slurry followed by causing the beads to disappear, or by coating a slurry onto a sponge-like base and causing the sponge-like base to disappear when sintered.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited to the foregoing description, and is only limited by the scope of the appended claims.

1. A fuel cell provided with a solid polymer electrolyte membrane and electrode sheets layered on both sides of the electrolyte membrane; wherein,
the electrode sheets are composed of an electrically conductive porous body composed by a sheet member having a framework having a three-dimensional mesh structure, a catalyst layer formed on one side of the electrically conductive porous body and made to contact the electrolyte layer, and a resin portion integrally formed by extending at least a portion of an outer peripheral edge of the electrically conductive porous body in a horizontal direction,
the electrically conductive porous body has a current collection portion formed to have a density in a portion thereof that is higher than other portions,
a resin penetrates into pores within the framework of the electrically conductive porous body at bound portions of the resin portion and the electrically conductive porous body, and
among the plurality of unit cells composed by the electrolyte membrane and the electrode sheets on both sides thereof, at least a portion thereof are connected in series by means of an electrically conductive member that passes through the electrolyte membrane from the current collection portion of the electrically conductive porous body.

2. The fuel cell according to claim 1, wherein the current collection portion has a laminated structure of a plurality of sheet members, and the pores in the framework of each sheet member in the current collection portion are formed to be pressed flatter than the pores of other portions.

3. The fuel cell according to claim 1, wherein the sheet members in the current collection portion have a dense sintered layer not having the pores formed on the surface layer thereof.

4. The fuel cell according to 1, wherein the porosity of the current collection portion is 40% to less than 60%, while the porosity of other portions is 60% to 98%.

5. The fuel cell according to claim 2, wherein the porosity of the current collection portion is 40% to less than 60%, while the porosity of other portions is 60% to 98%.

6. The fuel cell according to claim 3, wherein the porosity of the current collection portion is 40% to less than 60%, while the porosity of other portions is 60% to 98%.
